(19) United States
(12) Patent Application Publication
(10) Pub. No.: US 2025/0106890 A1
(43) Pub. Date: Mar. 27, 2025

(54) NETWORK CONTROLLED MEASUREMENT INTERRUPTION RATIO

(71) Applicant: Nokia Technologies Oy, Espoo (FI)

(72) Inventors: Jürgen HOFMANN, Munich (DE); Bent Henneberg RYSGAARD, Aalborg (DK); Rafael CAUDURO DIAS DE PAIVA, Aalborg (DK); Lars DALSGAARD, Oulu (FI); Tero HENTTONEN, Espoo (FI); Ping YUAN, Beijing (CN)

(21) Appl. No.: 18/819,470

(22) Filed: Aug. 29, 2024

(30) Foreign Application Priority Data
Sep. 27, 2023 (WO) PCT/CN2023/122315

(51) Int. Cl. H04W 74/0808; H04W 74/08; H04W 76/20

(52) U.S. Cl. CPC H04W 74/0808; H04W 74/0875; H04W 76/20

(57) ABSTRACT

Embodiments of the present disclosure relate to supporting network controlled measurement interruption ratio. In an aspect, a terminal device determines, based on at least one measurement requirement, a first interruption ratio. The first interruption ratio is different from a second interruption ratio acceptable by the network device. The terminal device transmits, to a network device, a first message requesting the network device to grant the first interruption ratio. By implementing the embodiments of the present disclosure, network controlled measurement interruption ratio can be supported and the negative impact caused by the interruptions could be reduced.

### CROSS-REFERENCE TO RELATED APPLICATION

This application claims priority to, and the benefit of, International Application No. PCT/CN2023/122315, filed Sep. 27, 2023, the contents of which are hereby incorporated by reference in their entirety.

### FIELD

Various example embodiments generally relate to the field of communication, and in particular, to a terminal device, network devices, methods, apparatuses and a computer readable storage medium related to supporting network controlled measurement interruption ratio.

### BACKGROUND

In a communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for wireless data traffic having increased since deployment of 4th generation (4G) communication systems, efforts have been made to develop an improved 5th generation (5G), pre-5G, 6G communication systems or beyond.

To allow for efficient use of inter-frequency measurements and inter-radio access technology (RAT) measurements, 3GPP agreed on that a UE may support measurements with or without gaps to one or more frequency bands. Measurements without gaps may cause interruptions.

### SUMMARY

In general, example embodiments of the present disclosure provide a terminal device, network devices, methods, apparatuses and a computer readable storage medium for communication, for example, for supporting measurements.

In a first aspect, there is provided a terminal device. The terminal device may comprise at least one processor and at least one memory storing instructions that, when executed by the at least one processor, cause the terminal device at least to: determine, based on at least one measurement requirement, a first interruption ratio; and transmit, to a network device, a first message requesting the network device to grant the first interruption ratio, wherein the first interruption ratio is different from a second interruption ratio acceptable by the network device.

In a second aspect, there is provided a network device. The network device may comprise at least one processor and at least one memory storing instructions that, when executed by the at least one processor, cause the network device at least to: receive, from a terminal device, a first message requesting the network device to grant a first interruption ratio, wherein the first interruption ratio is different from a second interruption ratio acceptable by the network device.

In a third aspect, there is provided a network device. The network device may comprise at least one processor and at least one memory storing instructions that, when executed by the at least one processor, cause the network device at least to: determine, based on at least one event, a fourth interruption ratio different from a second interruption ratio acceptable by the network device; and transmit, to the terminal device, a message comprising the fourth interruption ratio.

In a fourth aspect, there is provided a network device. The network device may comprise at least one processor and at least one memory storing instructions that, when executed by the at least one processor, cause the network device at least to: based on at least one event, determine to indicate a terminal device to perform measurements only within measurement gaps (MGs) and/or network controlled small gaps (NCSGs) for a time period; and transmit, to the terminal device, a message indicating the terminal device to perform measurements only within the MGs and/or the NCSGs for the time period.

In a fifth aspect, there is provided a method. The method may comprise: determining, based on at least one measurement requirement, a first interruption ratio; and transmitting, to a network device, a first message requesting the network device to grant the first interruption ratio, wherein the first interruption ratio is different from a second interruption ratio acceptable by the network device.

In a sixth aspect, there is provided a method. The method may comprise: receiving, from a terminal device, a first message requesting a network device to grant a first interruption ratio, wherein the first interruption ratio is different from a second interruption ratio acceptable by the network device.

In a seventeenth aspect, there is provided a method. The method may comprise: determining, based on at least one event, a fourth interruption ratio different from a second interruption ratio acceptable by the network device; and transmitting, to the terminal device, a message comprising the fourth interruption ratio.

In an eighth aspect, there is provided a method. The method may comprise: based on at least one event, determining to indicate a terminal device to perform measurements only within measurement gaps (MGs) and/or network controlled small gaps (NCSGs) for a time period; and transmitting, to the terminal device, a message indicating the terminal device to perform measurements only within the MGs and/or the NCSGs for the time period.

In a ninth aspect, there is provided an apparatus. The apparatus may comprise: means for determining, based on at least one measurement requirement, a first interruption ratio; and means for transmitting, to a network device, a first message requesting the network device to grant the first interruption ratio, wherein the first interruption ratio is different from a second interruption ratio acceptable by the network device.

In a tenth aspect, there is provided an apparatus. The apparatus may comprise: means for receiving, from a terminal device, a first message requesting a network device to grant a first interruption ratio, wherein the first interruption ratio is different from a second interruption ratio acceptable by the network device.

In an eleventh aspect, there is provided an apparatus. The apparatus may comprise: means for determining, based on at least one event, a fourth interruption ratio different from a second interruption ratio acceptable by the network device; and means for transmitting, to the terminal device, a message comprising the fourth interruption ratio.

In a twelfth aspect, there is provided an apparatus. The apparatus may comprise: means for based on at least one event, determining to indicate a terminal device to perform measurements only within measurement gaps (MGs) and/or network controlled small gaps (NCSGs) for a time period; and means for transmitting, to the terminal device, a message indicating the terminal device to perform measurements only within the MGs and/or the NCSGs for the time period.

In a thirteenth aspect, there is provided a non-transitory computer readable medium comprising program instructions for causing an apparatus to perform at least the method according to any of the fifth to eighth aspect.

In a fourteenth aspect, there is provided a computer program comprising instructions, which, when executed by an apparatus, cause the apparatus at least to: determine, based on at least one measurement requirement, a first interruption ratio; and transmit, to a network device, a first message requesting the network device to grant the first interruption ratio, wherein the first interruption ratio is different from a second interruption ratio acceptable by the network device.

In a fifteenth aspect, there is provided a computer program comprising instructions, which, when executed by an apparatus, cause the apparatus at least to: receive, from a terminal device, a first message requesting the network device to grant a first interruption ratio, wherein the first interruption ratio is different from a second interruption ratio acceptable by the network device.

In a sixteenth aspect, there is provided a computer program comprising instructions, which, when executed by an apparatus, cause the apparatus at least to: determine, based on at least one event, a fourth interruption ratio different from a second interruption ratio acceptable by the network device; and transmit, to the terminal device, a message comprising the fourth interruption ratio.

In a seventeenth aspect, there is provided a computer program comprising instructions, which, when executed by an apparatus, cause the apparatus at least to: based on at least one event, determine to indicate a terminal device to perform measurements only within measurement gaps (MGs) and/or network controlled small gaps (NCSGs) for a time period; and transmit, to the terminal device, a message indicating the terminal device to perform measurements only within the MGs and/or the NCSGs for the time period.

In an eighteenth aspect, there is provided a terminal device. The terminal device may comprise a determining circuitry configured to determine, based on at least one measurement requirement, a first interruption ratio; and a transmitting circuitry configured to transmit, to a network device, a first message requesting the network device to grant the first interruption ratio, wherein the first interruption ratio is different from a second interruption ratio acceptable by the network device.

In a nineteenth aspect, there is provided a network device. The network device may comprise a receiving circuitry configured to receive, from a terminal device, a first message requesting the network device to grant a first interruption ratio, wherein the first interruption ratio is different from a second interruption ratio acceptable by the network device.

In a twentieth aspect, there is provided a network device. The network device may comprise a determining circuitry configured to determine, based on at least one event, a fourth interruption ratio different from a second interruption ratio acceptable by the network device; and a transmitting circuitry configured to transmit, to the terminal device, a message comprising the fourth interruption ratio.

In a twenty-first aspect, there is provided a network device. The network device may comprise a determining circuitry configured to determine, based on at least one event, to indicate a terminal device to perform measurements only within measurement gaps (MGs) and/or network controlled small gaps (NCSGs) for a time period; and a transmitting circuitry configured to transmit, to the terminal device, a message indicating the terminal device to perform measurements only within the MGs and/or the NCSGs for the time period.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of an application scenario in which some example embodiments of the present disclosure may be implemented;

FIG. 2 illustrates an example signaling process of supporting network controlled measurement interruption ratio in accordance with some example embodiments of the present disclosure;

FIG. 3A illustrates an example signaling process of a network granting an interruption ratio in accordance with some example embodiments of the present disclosure;

FIG. 3B illustrates an example signaling process of a network rejecting an interruption ratio in accordance with some example embodiments of the present disclosure;

FIG. 3C illustrates an example signaling process of a network rejecting an interruption ratio in accordance with some other example embodiments of the present disclosure;

FIG. 3D illustrates an example signaling process of a network rejecting an interruption ratio in accordance with some other example embodiments of the present disclosure;

FIG. 4 illustrates a flowchart of an example method implemented at a terminal device in accordance with some embodiments of the present disclosure;

FIG. 5 illustrates a flowchart of an example method implemented at a network device in accordance with some embodiments of the present disclosure;

FIG. 6A illustrates a flowchart of another example method implemented at a network device in accordance with some embodiments of the present disclosure;

FIG. 6B illustrates a flowchart of yet another example method implemented at a network device in accordance with some embodiments of the present disclosure;

FIG. 7 illustrates an example simplified block diagram of an apparatus that is suitable for implementing embodiments of the present disclosure; and

FIG. 8 illustrates an example diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as new radio (NR), long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

In a cellular network, a UE may perform radio resource management (RRM) measurements, e.g., for secondary cell (SCell) activation, positioning, quality metrics, etc. The measurements are also necessary to ensure UE to stay connected to a best cell. Hence, as a minimum, the UE will continuously need to measure a serving cell and look for other neighbor cells while performing transmission on the serving carrier. However, in most cases, the UE additionally has to search for and measure the cells on other carriers rather than the serving carrier.

This is done by the network configuring the UE with which carriers to measure and when to report the acquired measurement results to the network. The UE will perform those measurements and reporting according to the network configuration, and the UE shall follow the UE requirements related to how often and how long the UE should measure and when to report these measurements.

For some carriers these measurements may be impossible without measurement gaps, wherein the UE will temporarily stop using the current serving carrier(s), tunes to the carrier(s) to be measured and performs measurements on the configured carrier(s) to be measured. Hence, the UE cannot receive data on the serving cell/carrier during the configured measurement gaps.

On some other carriers, the UE may be able to perform the measurements without gaps. However, performing such measurements may cause some interruptions to the serving carrier(s) in certain cases.

For robust network operations, the UE may need gaps to perform measurements on only specific component carriers, the network needs to know which carriers the UE can measure without gaps and for which carriers the UE needs gaps to measure (as network then needs to allocate gaps to the UE). Additionally, the network needs to know whether the UE causes interruptions on the serving carrier(s) during the measurements without gaps.

Network controlled small gaps (NCSG, already defined in LTE Rel-14) allows the network to specify when the interruptions are allowed. However, this still doesn't allow the network to verify that the UE shall use these gaps.

Per-frequency range (FR) and Per-UE measurement gaps allow the network to designate certain gaps to a certain FR if the UE supports the Per-FR measurement gap feature or to use the same measurement gap(s) in both FRs (mandatory per-UE measurement gap feature). Hence, the network can designate certain inter-FR measurements to specific measurement gaps without affecting the intra-FR measurements. However, intra-FR measurements may still cause interruptions or require measurement gaps.

RAN4 has defined extensive UE requirements related to measurements without measurement gaps and measurements using measurement gaps.

Additionally, UE requirements account for many different scenarios. For example:
Intra-frequency measurements without gaps
Intra-frequency measurements with gaps
Inter-frequency measurements with gaps
Inter-frequency measurements without gaps.

As discussed above, to allow for efficient use of inter-frequency measurements (also cover Inter-RAT measurements), the UE may support measurements without gaps with or without interruptions for one or more bands. There is a problem that if the UE can perform measurements on one or more carriers without gaps, but cause interruptions on the serving carrier(s), the network may not be possible to know when the UE causes those interruptions. Hence, for these bands, the UE is allowed to perform such measurements under an acceptable interruption ratio, so as to prevent that data throughput of the serving cell is too much impacted due to unknown scheduling restrictions.

However, in some cases, the UE may reside at the cell edge or in a coverage gap of the serving cell and may need to perform lots of measurement tasks to identify suitable candidate target cells for handover or cell reselection. In this case, the measurement tasks could temporarily increase, and UE may need to detect and measure candidate target cells that are unknown, not configured as part of the measurement object (i.e. “detected cells”). In this case, if the UE still has to follow the acceptable interruption ratio, the measurements may suffer a higher delay. If the UE does not follow the acceptable interruption ratio, the measurements may cause more interruptions. In some other cases, if the network configures the UE with MGs or NCSGs for a carrier for which the UE has indicated “gap” or “ncsg”, then the UE can only measure candidate target cells within the MGs or NCSGs, but not outside. The measurements outside the MGs or NCSGs may cause interruptions. However, how to reduce the negative impacts caused by the measurement interruptions has not been defined.

Therefore, example embodiments of the present disclosure provide solutions for supporting network controlled measurement interruption ratios. According to some embodiments of the present disclosure, a terminal device (e.g., a UE) determines, based on at least one measurement requirement (e.g., more measurement tasks need to be performed, or measurements in Synchronization Signal Block (SSB)-based Measurement Timing Configuration (SMTC) windows not overlapping with configured MGs and/or NCSGs need to be performed, etc.), a first interruption ratio, the first interruption ratio is different from a second interruption ratio acceptable by the network device. Then, the terminal device transmits, to a network device, a first message requesting the network device to grant the first interruption ratio. According to some other embodiments of the present disclosure, the network device determines, based on at least one event, a fourth interruption ratio different from a second interruption ratio acceptable by the network device. Then, the network device transmits, to the terminal device, a message comprising the fourth interruption ratio. According to yet some other embodiments of the present disclosure, the network device determines to indicate the terminal device to perform measurements only within MGs and/or NCSGs for a time period based on at least one event. Then, the network device transmits, to the terminal device, a message indicating the terminal device to perform measurements only within the MGs and/or the NCSGs for the time period.

It is understood that the above procedure steps may work together, in a flow of operations as described below, partly together or independently of each other. By implementing the embodiments of the present disclosure, the measurement interruption ratio could be controlled by the network device while still allowing efficient RRM measurements without gaps but with interruptions, thereby reducing the negative impact caused by the interruptions.

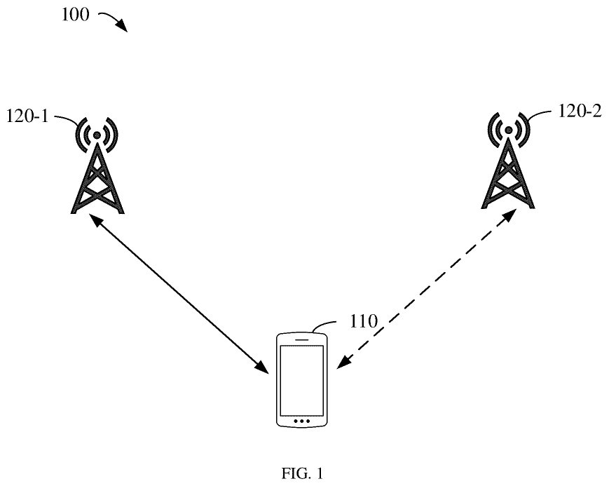

For illustrative purposes, principles and example embodiments of the present disclosure of supporting network controlled measurement interruption ratio will be described below with reference to FIG. 1 through FIG. 8. However, it is to be noted that these embodiments are given to enable the skilled in the art to understand inventive concepts of the present disclosure and implement the solutions as proposed herein, and not intended to limit scope of the present application in any way.

FIG. 1 illustrates an example of an application scenario 100 in which some example embodiments of the present disclosure may be implemented. The network environment 100, which may be a part of a communication network, includes a terminal device 110, a first network device 120-1, and a second network device 120-2.

As illustrated in FIG. 1, the terminal device 110 may also be referred to as a user equipment 110 or a UE 110. The first network device 120-1 may also be referred to as a gNB 120-1. The second network device 120-2 may also be referred to as a gNB 120-2. The first network device 120-1 may provide a serving cell for the terminal device 110, and the terminal device 110 and the first network device 120-1 can communicate with each other via a serving carrier of the serving cell. The second network device 120-2 may provide a neighbor cell for the terminal device 110. The terminal device 110 may perform measurements on the serving carrier and/or the neighbor carrier. The measurement types include but not limited to received signal strength indication (RSSI) measurement, quality of service (QOS) measurement, etc.

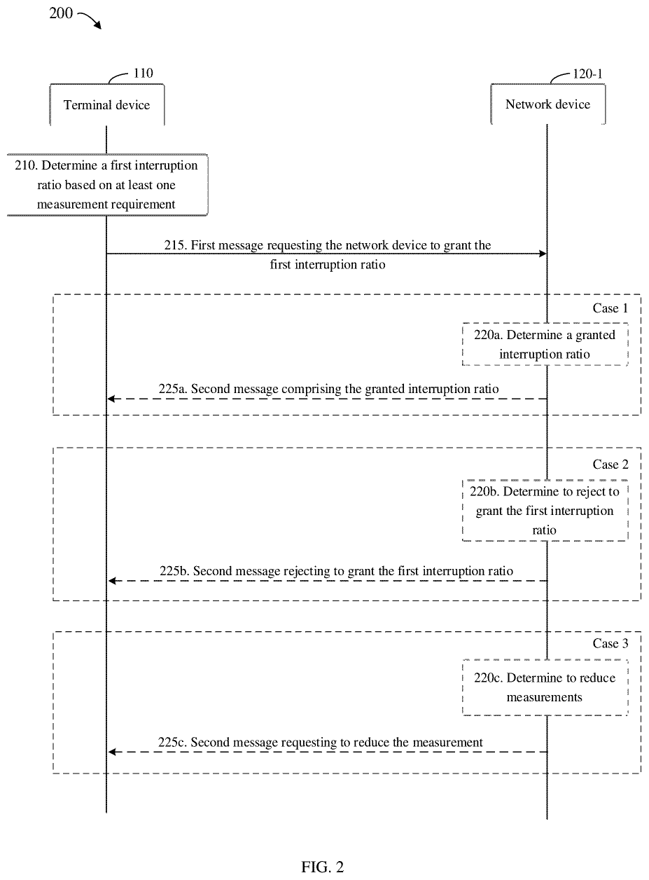

FIG. 2 illustrates an example signaling process 200 of supporting network controlled measurement interruption ratio in accordance with some example embodiments of the present disclosure. For ease of understanding, the process 200 will be described with reference to FIG. 1.

As shown in FIG. 2, the terminal device (e.g., the UE) 110 may be in communication with the network device (e.g., the first network device) 120-1. The terminal device 110 determines 210, based on at least one measurement requirement, a first interruption ratio (e.g., a target interruption ratio needed by the terminal device 110). The first interruption ratio may be different from a second interruption ratio acceptable by the network device 120-1. In some embodiments, the first interruption ratio may be higher than a second interruption ratio acceptable by the network device 120-1. Then, the terminal device 110 transmits to a network device 120-1, a first message 215 requesting the network device 120-1 to grant the first interruption ratio. Afterwards, in response to the first message, the network device 120-1 may perform control operations on the terminal device 110 so as to control the measurement interruption ratio. The control operations may comprise the operations in Case 1 to Case 3.

Regarding Case 1, in some example embodiments, the at least one measurement requirement may indicate that the terminal device 110 needs to perform more measurement tasks. In this case, more measurement tasks may cause more measurement interruptions. Alternatively or additionally, the at least one measurement requirement may indicate that the terminal device 110 needs to perform measurements in SMTC windows not overlapping with configured MGs and/or NCSGs. In this case, the measurements outside the MGs and/or NCSGs may cause more measurement interruptions.

In some example embodiments, the network device 120-1 may determine 220a a granted interruption ratio in response to the first message. The granted interruption ratio may be a first interruption ratio or a third interruption ratio different from the second interruption ratio. The third interruption ratio is different from the first interruption ratio and may be determined by the network device 120-1. In some embodiments, the third interruption ratio may be higher than a second interruption ratio acceptable by the network device 120-1. Then, the network device 120-1 may transmit, to the terminal device 110, a second message 225a comprising the granted interruption ratio.

In some example embodiments, the network device 120-1 may determine a first time period for the granted interruption ratio in response to the first message 215. The second message 225a may comprise the first time period during which the granted interruption ratio could be used. In this way, the terminal device 110 could perform measurements under the granted interruption ratio allowed by the network device 120-1.

In some example embodiments, the network device 120-1 may determine the granted interruption ratio based on a service type (e.g., ultra-high speed service, low latency service, etc.) provided to the terminal device 110. Alternatively or additionally, the network device 120-1 may determine the granted interruption ratio based on a connected mode (e.g., radio resource control (RRC) connected state, RRC inactive state, etc.) of the terminal device. Alternatively or additionally, the network device 120-1 may determine the granted interruption ratio based on a network load. Alternatively or additionally, the network device 120-1 may determine the granted interruption ratio based on a duration of at least one measurement interruption.

In some example embodiments, the terminal device 110 may determine a second time period for the granted interruption ratio. The second time period may be different from the first time period. In some embodiments, the second time period may be longer than the first time period. Then, the terminal device 110 may transmit, to the network device 120-1, a third message requesting the second time period for the granted interruption ratio. Then, the network device 120-1 may determine to grant or reject the second time period requested by the terminal device 110 in response to the third message. Then, the network device 120-1 may transmit, to the terminal device 110, a fourth message granting or rejecting the second time period.

Regarding Case 2, in some example embodiments, the network device 120-1 may determine 220b to reject to grant the first interruption ratio in response to the first message 215. Then, the network device 120-1 may transmit, to the terminal device 110, a second message 225b rejecting to grant the first interruption ratio. In this way, the terminal device 110 could continue performing measurements under a previous interruption ratio.

Regarding Case 3, in some example embodiments, the network device 120-1 may determine to reduce (or, relax) measurements in response to the first message 220c. Then, the network device 120-1 may transmit, to the terminal device, a second message 225c requesting to reduce the measurements. In turn, the terminal device 110 may perform, based on the second message 225c, at least one operation for reducing the measurements. In this way, the terminal device 110 could reduce the measurements, thereby reducing the interruptions caused by the measurements. Alternatively or additionally, the terminal device 110 may be reconfigured with more measurement gaps based on the second message 225c.

In some example embodiments, the at least one operation for reducing the measurements comprises reducing a number of measurements performed on all carriers which cause the measurement interruptions. In this way, the terminal device 110 may reduce the number of measurements performed on all carrier in general. Alternatively or additionally, the at least one operation for reducing the measurements comprises reducing a number of measurements performed on at least one carrier which cause the measurement interruptions. Alternatively or additionally, the at least one operation for reducing the measurements comprises stopping measurements performed on at least one carrier which cause the measurement interruptions. In this way, the terminal device 110 may reduce or stop the measurements on certain carriers to a level, e.g., according to the amount of interruptions allowed or specified by the network device 120-1. Alternatively or additionally, the at least one operation for reducing the measurements comprises reducing a number of measurements performed on at least one carrier for at least one measurement type which cause the measurement interruptions. Alternatively or additionally, the at least one operation for reducing the measurements comprises stopping measurements performed on at least one carrier for at least one measurement type which cause the measurement interruptions.

In some example embodiments, the at least one carrier may have a pre-defined priority. Alternatively, the at least one carrier may have a priority configured by the network device 120-1. The pre-defined priority or the priority configured by the network device 120-1 may be a low priority, and the measurements of the at least one carrier having the low priority may be reduced prior to the measurements of the carrier(s) having a high priority.

In some example embodiments, the at least one measurement type may be configured based on a pre-defined priority rule. Alternatively, the at least one measurement type may be configured based on a priority rule signaled by the network device 120-1. The measurements of the at least one carrier for the at least one measurement type configured based on the priority rule may be reduced.

In addition to Case 1 to Case 3, in some example embodiments, the network device 120-1 may determine to indicate the terminal device 110 to perform measurements only within configured MGs and/or NCSGs for a third time period. Then, the network device 120-1 may transmit, to the terminal device 110, a second message for indicating the terminal device 110 to perform measurements only within the MGs and/or the NCSGs for the third time period. In this way, the network device 120-1 could command the terminal device 110 to perform only gap/NCSG-assisted measurements for a given time period, thereby reducing the interruptions caused by the measurements outside the MGs or NCSGs.

In some example embodiments, the network device 120-1 may determine the MGs and/or the NCSGs to be configured to the terminal device 110. Then, the network device 120-1 may transmit, to the terminal device 110, configuration information of the MGs and/or the NCSGs via the second message.

In some example embodiments, the first message 215, the second message 225, the third message or the fourth message is a RRC signaling or a media access control (MAC) control element (CE) signaling.

The above contents mainly describe the scenarios in which the measurement interruption ratio is controlled by the network device 120-1 per the request of the terminal device 110. Alternatively, the measurement interruption ratio may be controlled by the network device 120-1 without the request of the terminal device 110. Specifically, in some example embodiments, the network device 120-1 may determine, based on at least one event, a fourth interruption ratio different from a second interruption ratio acceptable by the network device 120-1. Then, the network device 120-1 may transmit, to the terminal device 120-1, a message comprising the fourth interruption ratio. In this way, the network device 120-1 may initiatively detect the at least one event, and indicate an interruption ratio to the terminal device 110. In some other example embodiments, based on at least one event, the network device 120-1 may determine to indicate a terminal device 110 to perform measurements only within MGs and/or NCSGs for a time period. Then, the network device 120-1 may transmit, to the terminal device 110, a message indicating the terminal device 110 to perform measurements only within the MGs and/or the NCSGs for the time period. In this way, the network device 120-1 may initiatively detect the at least one event, and command the terminal device 110 to perform only gap/NCSG-assisted measurements for a given time period, thereby reducing the interruptions caused by the measurements outside the MGs or NCSGs.

In some example embodiments, the at least one event may comprise an interruption ratio different from an acceptable interruption ratio is needed. For example, the at least one event may comprise an interruption ratio higher than an acceptable interruption ratio is needed. Alternatively or additionally, the at least one event may comprise a high QoS is needed. Alternatively or additionally, the at least one event may comprise a high network load.

By implementing the above embodiments described with reference to FIG. 2, network controlled measurement interruption ratio is supported. With the network controlled measurement interruption ratio as described above, the measurement interruption ratio could be controlled by the network device 120-1 while still allowing efficient RRM measurements without gaps but with interruptions, thereby reducing the negative impact caused by the interruptions.

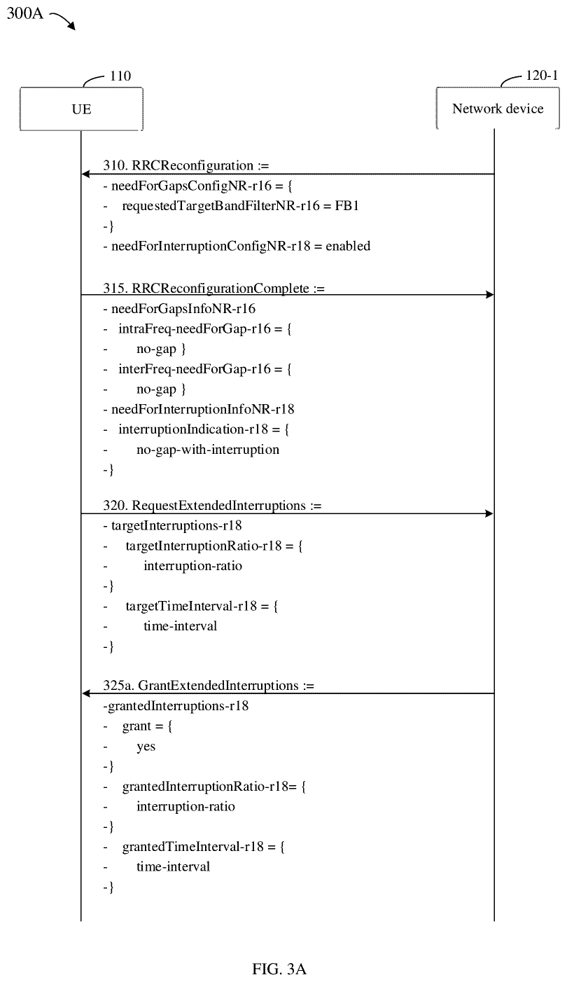

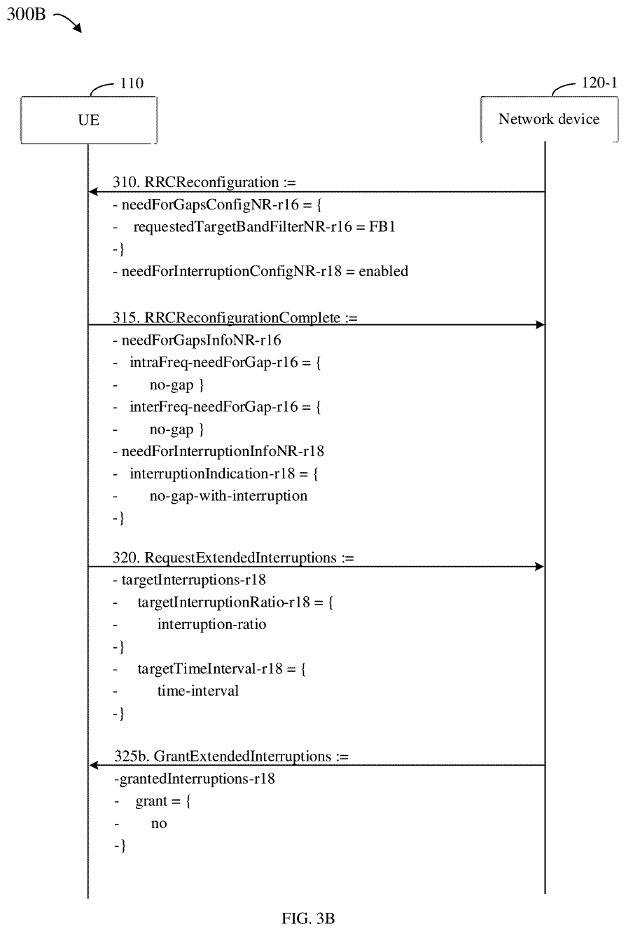

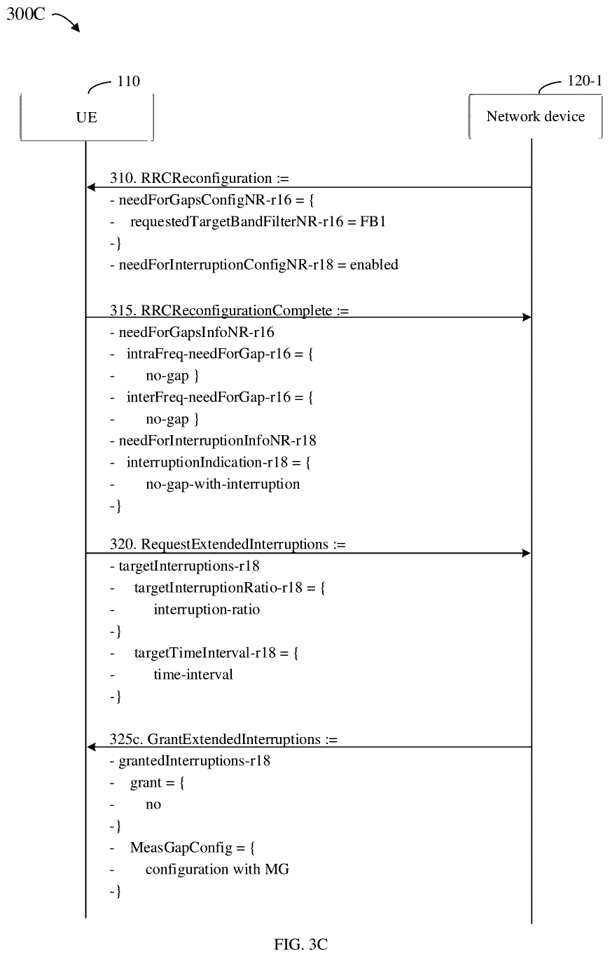

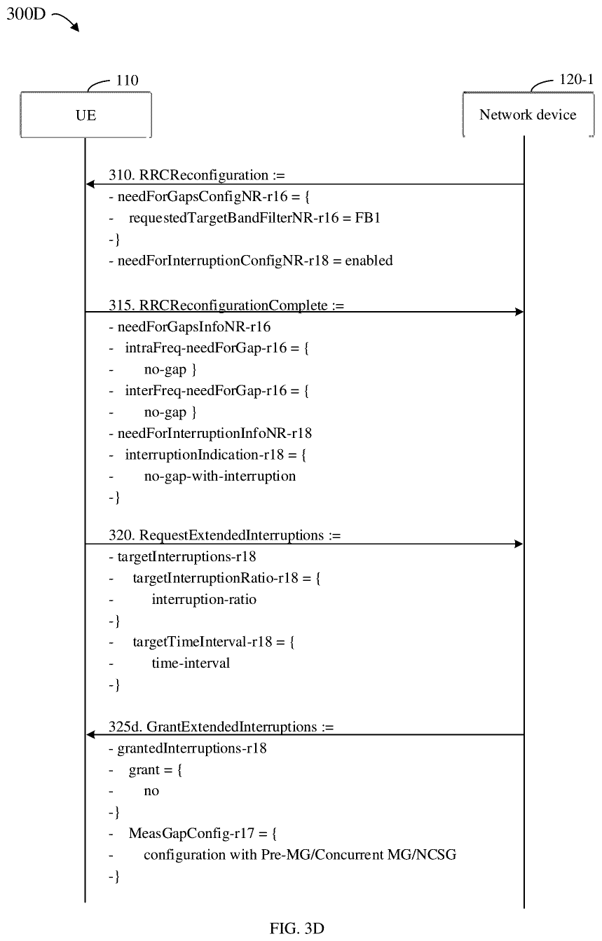

FIG. 3A illustrates an example signaling process 300A of a network granting an interruption ratio in accordance with some example embodiments of the present disclosure. It is noted that the process 300A may be considered as an embodiment or a more specific example of the process 200 as shown in FIG. 2. For ease of understanding, the process 300A will be described with reference to FIG. 1.

As shown in FIG. 3A, at 310, the terminal device (e.g., the UE) 110 may transmit a RRCReconfiguration message to the network device 120-1. The RRCReconfiguration message may comprise a field of needForGapsConfigNR-r16 which contains a field of requestedTargetBandFilterNR-r16. The field of requestedTargetBandFilterNR-r16 is configured as “FB1”, informing the UE 110 that the target band is frequency band 1. The RRCReconfiguration message may also comprise a field of needForInterruptionConfigNR-r18, which is configured as “enabled”, indicating the UE 110 to report whether it supports the measurement with or without interruptions.

At 315, the terminal device 110 may reply a RRCReconfigurationComplete message to the network device 120-1. The RRCReconfigurationComplete message may comprise a field of needForGapsInfoNR-r16 which contains a field of intraFreq-needForGap-r16 and a field of interFreq-needForGap-r16. The field of intraFreq-needForGap-r16 is configured as “no-gap”, informing the network device 120-1 that the UE 110 can perform intra-frequency measurements without MGs. The field of interFreq-needForGap-r16 is configured as “no-gap”, informing the network device 120-1 that the UE 110 can perform inter-frequency measurements without MGs. The RRCReconfigurationComplete message may also comprise a field of needForInterruptionInfoNR-r18 which contains a field of interruptionIndication-r18. The field of interruptionIndication-r18 is configured as “no-gap-with-interruption”, informing the network device 120-1 that the UE 110 can perform the measurements without MGs but with interruptions.

At 320, the UE 110 may transmit a RequestExtendedInterruptions message to the network device 120-1 so as to request the network device 120-1 to allow an interruption ratio different from the acceptable interruption ratio. For example, the requested interruption ratio may be higher than the acceptable interruption ratio. The RequestExtendedInterruptions message may comprise a field of targetInterruptions-r18, which contains a field of targetInterruptionRatio-r18. The field of targetInterruptionRatio-r18 may contain a value of “interruption-ratio”, which is an interruption ratio required by the UE 110 and also could also be referred to as a first interruption ratio or a target interruption ratio. The RequestExtendedInterruptions message may also comprise a field of targetTimeInterval-r18, which may contain a value of “time-interval”, namely a time period (also can be referred to as a first time period) required by the UE 110 for the first interruption ratio.

At 325a, the network device 120-1 may reply a GrantExtendedInterruptions message to the terminal device 110. The GrantExtendedInterruptions message may comprise a field of grantedInterruptions-r18 which contains a field of grant. The field of grant may be configured as “yes”, informing the UE 110 that the network grants an interruption ratio different from the acceptable interruption ratio to the UE 110. The GrantExtendedInterruptions message may also comprise a field of grantedInterruptionRatio-r18. The field of grantedInterruptionRatio-r18 may contain a value of “interruption-ratio”, which is an interruption ratio determined by the network device 120-1 and also could also be referred to as a granted interruption ratio. The granted interruption ratio may be the first interruption ratio or a third interruption ratio different from the acceptable interruption ratio. For example, the granted interruption ratio may be higher than the acceptable interruption ratio. The GrantExtendedInterruptions message may also comprise a field of grantedTimeInterval-r18. The field of grantedInterruptionRatio-r18 may also contain a value of “time-interval”, which is a time period (also can be referred to as a second time period) determined by the network device 120-1 for the target interruption ratio.

By implementing the above embodiments described with reference to FIG. 3A, the network device 120-1 could grant an interruption ratio different from the acceptable interruption ratio to the UE 110 to allow more interruptions.

FIG. 3B illustrates an example signaling process 300B of a network rejecting an interruption ratio in accordance with some example embodiments of the present disclosure. It is noted that the process 300B may be considered as an embodiment or a more specific example of the process 200 as shown in FIG. 2. For ease of understanding, the process 300B will be described with reference to FIG. 1.

Generally, FIG. 3B mainly differs from FIG. 3A at the last message, namely the GrantExtendedInterruptions message. As shown in FIG. 3B, at 325b, the network device 120-1 may reply a GrantExtendedInterruptions message to the terminal device 110 in response to the RequestExtendedInterruptions message in 320. The GrantExtendedInterruptions message may comprise a field of grantedInterruptions-r18 which contains a field of grant. The field of grant may be configured as “no”, informing the UE 110 that the network rejects to grant an interruption ratio different from the acceptable interruption ratio to the UE 110.

By implementing the above embodiments described with reference to FIG. 3B, the network device 120-1 could reject to grant an interruption ratio different from the acceptable interruption ratio to the UE 110. As such, the terminal device 110 may continue performing measurements under a previous interruption ratio.

FIG. 3C illustrates an example signaling process 300C of a network rejecting an interruption ratio in accordance with some other example embodiments of the present disclosure. It is noted that the process 300C may be considered as an embodiment or a more specific example of the process 200 as shown in FIG. 2. For ease of understanding, the process 300C will be described with reference to FIG. 1.

Generally, FIG. 3C mainly differs from FIG. 3A and FIG. 3B at the last message, namely the GrantExtendedInterruptions message. As shown in FIG. 3C, at 325c, the network device 120-1 may reply a GrantExtendedInterruptions message to the terminal device 110 in response to the RequestExtendedInterruptions message in 320. The GrantExtendedInterruptions message may comprise a field of grantedInterruptions-r18 which contains a field of grant. The field of grant may be configured as “no”, informing the UE 110 that the network rejects to grant an interruption ratio different from the acceptable interruption ratio to the UE 110. The GrantExtendedInterruptions message may also comprise a field of MeasGapConfig which may contain an information of “configuration with MG”, indicating the UE 110 to perform measurements only within the legacy MGs based on the configuration information of the legacy MGs.

By implementing the above embodiments described with reference to FIG. 3C, the network device 120-1 could reject to grant an interruption ratio different from the acceptable interruption ratio to the UE 110 and command the terminal device 110 to perform only measurements within the legacy MGs.

FIG. 3D illustrates an example signaling process 300D of a network rejecting an interruption ratio in accordance with some other example embodiments of the present disclosure. It is noted that the process 300D may be considered as an embodiment or a more specific example of the process 200 as shown in FIG. 2. For ease of understanding, the process 300D will be described with reference to FIG. 1.

Generally, FIG. 3D mainly differs from FIG. 3A to FIG. 3C at the last message, namely the GrantExtendedInterruptions message. As shown in FIG. 3D, at 325d, the network device 120-1 may reply a GrantExtendedInterruptions message to the terminal device 110 in response to the RequestExtendedInterruptions message in 320. The GrantExtendedInterruptions message may comprise a field of grantedInterruptions-r18 which contains a field of grant. The field of grant may be configured as “no”, informing the UE 110 that the network rejects to grant an interruption ratio different from the acceptable interruption ratio to the UE 110. The GrantExtendedInterruptions message may also comprise a field of MeasGapConfig. The field of MeasGapConfig may contain an information of “configuration with Pre-MG”, indicating the UE 110 to perform measurements only within the preconfigured MGs based on the configuration information of the preconfigured MGs. Alternatively or additionally, the field of MeasGapConfig may contain an information of “configuration with Concurrent-MG”, indicating the UE 110 to perform measurements only within the concurrent MGs based on the configuration information of the concurrent MGs. Alternatively or additionally, the field of MeasGapConfig may contain an information of “configuration with NCSG”, indicating the UE 110 to perform measurements only within the NCSGs based on the configuration information of the NCSGs.

By implementing the above embodiments described with reference to FIG. 3D, the network device 120-1 could reject to grant an interruption ratio different from the acceptable interruption ratio to the UE 110 and command the terminal device 110 to perform only measurements within different types of gaps, e.g., the preconfigured MGs, the concurrent MGs and/or the NCSGs. For example, when the terminal device 110 is requesting for a target interruption ratio that does not fit the demands of the network device 120-1, with the above embodiments described with reference to FIG. 3D, the network could reconfigure the MGs and/or the NCSGs to reduce the measurement interruptions.

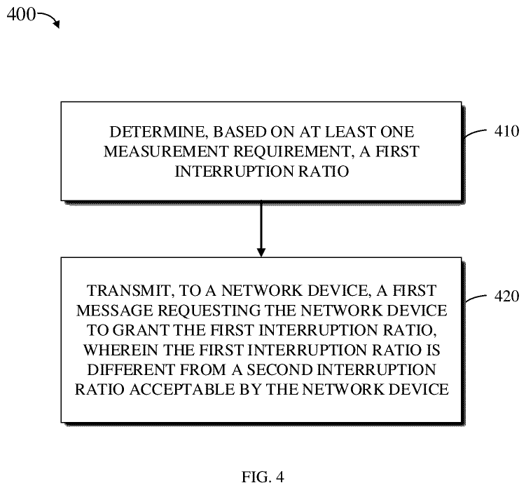

FIG. 4 illustrates a flowchart of an example method 400 implemented at a terminal device (for example, the terminal device 110 or the UE 110) in accordance with some embodiments of the present disclosure. For ease of understanding, the method 400 will be described from the perspective of the terminal device 110 with reference to FIG. 1 to FIG. 3D.

At block 410, the terminal device 110 may determine, based on at least one measurement requirement, a first interruption ratio. At block 420, the terminal device 110 may transmit, to a network device 120-1, a first message requesting the network device 120-1 to grant the first interruption ratio, wherein the first interruption ratio is different from a second interruption ratio acceptable by the network device 120-1.

In some example embodiments, the terminal device 110 may receive, from the network device 120-1, a second message comprising a granted interruption ratio, which is the first interruption ratio or a third interruption ratio different from the second interruption ratio.

In some example embodiments, the second message may further comprise a first time period for the granted interruption ratio.

In some example embodiments, the granted interruption ratio may be determined based on at least one of the following: a service type provided to the terminal device 110; a connected mode of the terminal device 110; a network load; or a duration of at least one measurement interruption.

In some example embodiments, the terminal device 110 may be further caused to: determine a second time period for the granted interruption ratio, the second time period being different from the first time period; and transmit, to the network device 120-1, a third message requesting the second time period for the granted interruption ratio.

In some example embodiments, the terminal device 110 may be further caused to: receive, from the network device 120-1, a fourth message granting or rejecting the second time period requested by the terminal device 110.

In some example embodiments, the terminal device 110 may be further caused to: receive, from the network device 120-1, a second message rejecting to grant the first interruption ratio.

In some example embodiments, the terminal device 110 may be further caused to: receive, from the network device 120-1, a second message requesting to reduce measurements; and perform, based on the second message, at least one operation for reducing the measurements.

In some example embodiments, the at least one operation may comprise at least one of the following: reducing a number of measurements performed on all carriers which cause the measurement interruptions; reducing a number of measurements performed on at least one carrier which cause the measurement interruptions; stopping measurements performed on at least one carrier which cause the measurement interruptions; reducing a number of measurements performed on at least one carrier for at least one measurement type which cause the measurement interruptions; or stopping measurements performed on at least one carrier for at least one measurement type which cause the measurement interruptions.

In some example embodiments, the at least one carrier has a pre-defined priority or a priority configured by the network device 120-1.

In some example embodiments, the at least one measurement type is configured based on a pre-defined priority rule or a priority rule signaled by the network device 120-1.

In some example embodiments, the terminal device 110 is further caused to: receive, from the network device 120-1, a second message indicating the terminal device 110 to perform measurements only within configured measurement gaps (MGs) and/or network controlled small gaps (NCSGs) for a third time period.

In some example embodiments, the second message may comprise configuration information of the MGs and/or NCSGs.

In some example embodiments, the first message, the second message, the third message or the fourth message may be a radio resource control (RRC) signaling or a media access control (MAC) control element (CE) signaling.

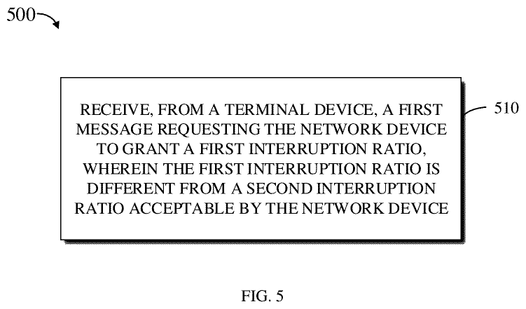

FIG. 5 illustrates a flowchart of an example method 500 implemented at a network device (for example, the network device 120-1) in accordance with some embodiments of the present disclosure. For ease of understanding, the method 500 will be described from the perspective of the network device 120-1 with reference to FIG. 1 to FIG. 3D.

At block 510, the network device 120-1 may receive, from a terminal device 110, a first message requesting the network device 120-1 to grant a first interruption ratio, wherein the first interruption ratio is different from a second interruption ratio acceptable by the network device 120-1.

In some example embodiments, the network device 120-1 is further caused to:
determine a granted interruption ratio in response to the first message, the granted interruption ratio is the first interruption ratio or a third interruption ratio different from the second interruption ratio; transmit, to the terminal device 110, a second message comprising the granted interruption ratio.

In some example embodiments, the second message may further comprise a first time period for the granted interruption ratio, the network device 120-1 may be further caused to: determine the first time period in response to the first message.

In some example embodiments, the network device 120-1 may be further caused to determine the granted interruption ratio based on at least one of the following: a service type provided to the terminal device 110; a connected mode of the terminal device 110; a network load; or a duration of at least one measurement interruption.

In some example embodiments, the network device 120-1 may be further caused to: receive, from the terminal device 110, a third message requesting a second time period for the granted interruption ratio, the second time period being different from the first time period.

In some example embodiments, the network device 120-1 may be further caused to: determine to grant or reject the second time period requested by the terminal device 110 in response to the third message; and transmit, to the terminal device 110, a fourth message granting or rejecting the second time period.

In some example embodiments, the network device 120-1 may be further caused to: determine to reject to grant the first interruption ratio in response to the first message; transmit, to the terminal device 110, a second message rejecting to grant the first interruption ratio.

In some example embodiments, the network device 120-1 may be further caused to: determine to reduce measurements in response to the first message. Then, the network device 120-1 may be further caused to: transmit, to the terminal device 110, a second message requesting to reduce the measurements. Alternatively or additionally, the network device 120-1 may be further caused to: transmit, to the terminal device 110, a second message reconfiguring the terminal device 110 with more measurement gaps.

In some example embodiments, the measurements which cause the measurement interruptions may be reduced by at least one of the following: reducing a number of measurements performed on all carriers which cause the measurement interruptions; reducing a number of measurements performed on at least one carrier which cause the measurement interruptions; stopping measurements performed on at least one carrier which cause the measurement interruptions; reducing a number of measurements performed on at least one carrier for at least one measurement type which cause the measurement interruptions; or stopping measurements performed on at least one carrier for at least one measurement type which cause the measurement interruptions.

In some example embodiments, the at least one carrier has a pre-defined priority or a priority configured by the network device 120-1.

In some example embodiments, the at least one measurement type may be configured based on a pre-defined priority rule or a priority rule signaled by the network device 120-1.

In some example embodiments, the network device 120-1 may be further caused to: determine to indicate the terminal device 110 to perform measurements only within configured measurement gaps (MGs) and/or network controlled small gaps (NCSGs) for a third time period; and transmit, to the terminal device, a second message for indicating the terminal device 110 to perform measurements only within the MGs and/or the NCSGs for the third time period.

In some example embodiments, the network device 120-1 may be further caused to: determine the MGs and/or the NCSGs to be configured to the terminal device 110; and transmit, to the terminal device 110, configuration information of the MGs and/or the NCSGs via the second message.

In some example embodiments, the first message, the second message, the third message or the fourth message is a radio resource control (RRC) signaling or a media access control (MAC) control element (CE) signaling.

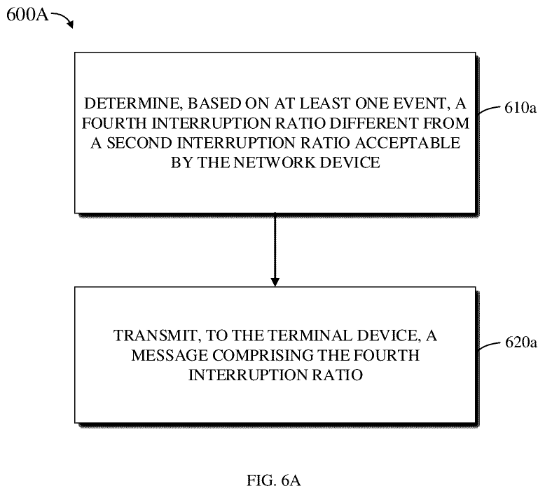

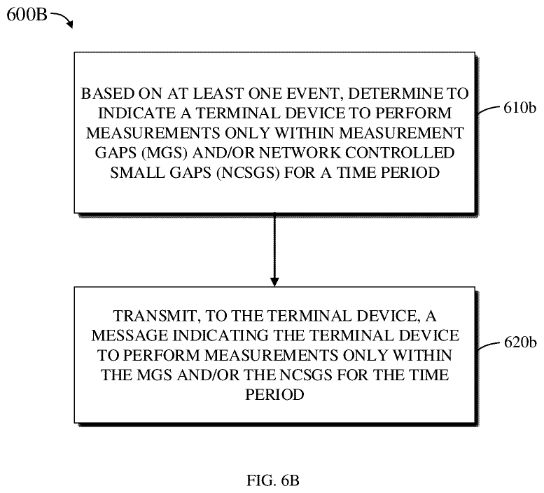

FIG. 6A illustrates a flowchart of another example method 600A implemented at a network device (for example, the network device 120-1) in accordance with some embodiments of the present disclosure. For ease of understanding, the method 600A will be described from the perspective of the network device 120-1 with reference to FIG. 1 to FIG. 3D.

At block 610a, the network device 120-1 may determine, based on at least one event, a fourth interruption ratio different from a second interruption ratio acceptable by the network device 120-1. At block 620b, the network device 120-1 may transmit, to the terminal device 110, a message comprising the fourth interruption ratio.

In some example embodiments, the fourth interruption ratio may be an interruption ratio initially configured to the terminal device 110 or used for replacing an interruption ratio previously used by the terminal device 110.

FIG. 6B illustrates a flowchart of another example method 600B implemented at a network device (for example, the network device 120-1) in accordance with some embodiments of the present disclosure. For ease of understanding, the method 600B will be described from the perspective of the network device 120-1 with reference to FIG. 1 to FIG. 3D.

At block 610b, the network device 120-1 may determine, based on at least one event, to indicate a terminal device 110 to perform measurements only within measurement gaps (MGs) and/or network controlled small gaps (NCSGs) for a time period. At block 620b, the network device 120-1 may transmit, to the terminal device 110, a message indicating the terminal device 110 to perform measurements only within the MGs and/or the NCSGs for the time period. In some example embodiments, the at least one event may comprise at least one of the following: an interruption ratio different from an acceptable interruption ratio is needed; a high quality of service (QOS) is needed; or a high network load.

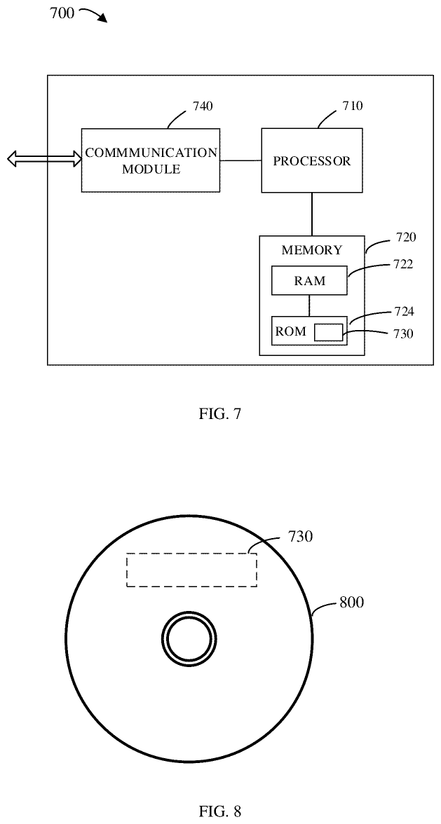

FIG. 7 illustrates an example simplified block diagram of an apparatus 700 that is suitable for implementing embodiments of the present disclosure. The apparatus 700 may be provided to implement a communication device or a network element, for example, the network device 120-1, the network device 120-2 and the terminal device 110 as shown in FIG. 1. As shown, the apparatus 700 includes one or more processors 710, one or more memories 720 may couple to the processor 710, and one or more communication modules 740 may couple to the processor 710.

The communication module 740 is for bidirectional communications. The communication module 740 has at least one antenna to facilitate communication. The communication interface may represent any interface that is necessary for communication with other network elements, for example the communication interface may be wireless or wireline to other network elements, or software based interface for communication.

The processor 710 may be of any type suitable to the local technical network and may include one or more of the following: general purpose computers, special purpose computers, microprocessors, digital signal processors (DSPs) and processors based on multicore processor architecture, as non-limiting examples. The apparatus 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a read only memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program so that the apparatus 700 may perform any process of the disclosure as discussed with reference to FIG. 2 to FIG. 6B. The embodiments of the present disclosure may also be implemented by hardware or by a combination of software and hardware.

In some example embodiments, the program 730 may be tangibly contained in a computer readable medium which may be included in the apparatus 700 (such as in the memory 720) or other storage devices that are accessible by the apparatus 700. The apparatus 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example diagram 800 of the computer readable medium 730 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400, 500, or 600 as described above with reference to FIG. 4 to FIG. 6B. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one processor; and
at least one memory storing instructions that, when executed by the at least one processor, cause the terminal device at least to:
determine, based on at least one measurement requirement, a first interruption ratio; and
transmit, to a network device, a first message requesting the network device to grant the first interruption ratio, wherein the first interruption ratio is different from a second interruption ratio acceptable by the network device.

2. The terminal device of claim 1, wherein the terminal device is further caused to:
receive, from the network device, a second message comprising a granted interruption ratio, which is the first interruption ratio or a third interruption ratio different from the second interruption ratio.

3. The terminal device of claim 2, wherein the second message further comprises a first time period for the granted interruption ratio.

4. The terminal device of claim 3, wherein the terminal device is further caused to:
determine a second time period for the granted interruption ratio, the second time period being different from the first time period; and
transmit, to the network device, a third message requesting the second time period for the granted interruption ratio.

5. The terminal device of claim 4, wherein the terminal device is further caused to:
receive, from the network device, a fourth message granting or rejecting the second time period requested by the terminal device.

6. The terminal device of claim 2, wherein the granted interruption ratio is determined based on at least one of the following:
a service type provided to the terminal device;
a connected mode of the terminal device;
a network load; or
a duration of at least one measurement interruption.

7. The terminal device of claim 1, wherein the terminal device is further caused to:
receive, from the network device, a second message rejecting to grant the first interruption ratio.

8. The terminal device of claim 1, wherein the terminal device is further caused to:
receive, from the network device, a second message requesting to reduce measurements; and
perform, based on the second message, at least one operation for reducing the measurements.

9. The terminal device of claim 8, wherein the at least one operation comprises at least one of the following:
reducing a number of measurements performed on all carriers which cause the measurement interruptions;
reducing a number of measurements performed on at least one carrier which cause the measurement interruptions;
stopping measurements performed on at least one carrier which cause the measurement interruptions;
reducing a number of measurements performed on at least one carrier for at least one measurement type which cause the measurement interruptions; or
stopping measurements performed on at least one carrier for at least one measurement type which cause the measurement interruptions.

10. The terminal device of claim 9,
wherein the at least one carrier has a pre-defined priority or a priority configured by the network device; and/or
wherein the at least one measurement type is configured based on a pre-defined priority rule or a priority rule signaled by the network device.

11. The terminal device of claim 1, wherein the terminal device is further caused to:
receive, from the network device, a second message indicating the terminal device to perform measurements only within configured measurement gaps (MGs) and/or network controlled small gaps (NCSGs) for a third time period.

12. The terminal device of claim 11, wherein the second message comprises configuration information of the MGs and/or NCSGs.

13. A network device comprising:
at least one processor; and
at least one memory storing instructions that, when executed by the at least one processor, cause the network device at least to:
receive, from a terminal device, a first message requesting the network device to grant a first interruption ratio, wherein the first interruption ratio is different from a second interruption ratio acceptable by the network device.

14. The network device of claim 13, wherein the network device is further caused to:
determine a granted interruption ratio in response to the first message, the granted interruption ratio is the first interruption ratio or a third interruption ratio different from the second interruption ratio;
transmit, to the terminal device, a second message comprising the granted interruption ratio.

15. The network device of claim 14, wherein the second message further comprises a first time period for the granted interruption ratio, the network device is further caused to:
determine the first time period in response to the first message.

16. The network device of claim 14, wherein the network device is further caused to determine the granted interruption ratio based on at least one of the following:
a service type provided to the terminal device;
a connected mode of the terminal device;
a network load; or
a duration of at least one measurement interruption.

17. The network device of claim 15, wherein the network device is further caused to:
receive, from the terminal device, a third message requesting a second time period for the granted interruption ratio, the second time period being different from the first time period.

18. The network device of claim 13, wherein the network device is further caused to:
determine to reject to grant the first interruption ratio in response to the first message and transmit, to the terminal device, a second message rejecting to grant the first interruption ratio; or
determine to reduce measurements in response to the first message and transmit, to the terminal device, a second message requesting to reduce the measurements.

19. The network device of claim 13, wherein the network device is further caused to:
determine to indicate the terminal device to perform measurements only within configured measurement gaps (MGs) and/or network controlled small gaps (NCSGs) for a third time period; and
transmit, to the terminal device, a second message for indicating the terminal device to perform measurements only within the MGs and/or the NCSGs for the third time period.

20. A method comprising:
determining, based on at least one measurement requirement, a first interruption ratio; and
transmitting, to a network device, a first message requesting the network device to grant the first interruption ratio, wherein the first interruption ratio is different from a second interruption ratio acceptable by the network device.
